(19) United States
(12) Patent Application Publication
(10) Pub. No.: US 2012/0290451 A1
(43) Pub. Date: Nov. 15, 2012

(54) INTEGRATED DEPOSIT ACCOUNT FEE SYSTEM AND METHOD

(75) Inventors: Bradley M. Jones, Cumming, GA (US); Thomas T. Bennett, Cumming, GA (US)

(73) Assignee: PROFIT TECHNOLOGIES USA LLC, Huntersville, NC (US)

(21) Appl. No.: 13/107,550

(22) Filed: May 13, 2011

(51) Int. Cl. G06Q 40/00

(52) U.S. Cl. 705/30

(57) ABSTRACT

Systems and methods are described for managing deposit accounts whereby deposit account customers can receive fee ‘credits’ for performing certain banking activities and such credits may be applied to their present period deposit account management fee or may be accrued and applied to subsequent period deposit account management fees. Accrued credits also may be applied to other subsequent period service fees or, after a certain period of time, may be converted to alternative forms of value for the customer.

### TECHNICAL FIELD

The invention relates to the field of financial services and, more particularly, to a system and method for managing the account fee structure associated with customer deposit accounts.

### BACKGROUND

The profitability dynamics for customer checking accounts are changing. In recent years, checking profitability has been driven by two segments: Low Balance Transactor Customers and High Balance Relationship Customers. Low Balance Transactor customers typically utilize Free Checking Accounts or Basic Checking Accounts (with low deposit account management fees and low balance or activity requirements to avoid the deposit account management fee). This segment is characterized by minimal checking account balances and high utilization of multiple transaction products, such as debit cards, credit cards and online bill pay services. These customers produce checking account profit for their financial institution through Insufficient Funds (NSF) and Overdraft (OD) fee income and debit card interchange. On the other hand, High Balance Relationship Customers typically utilize feature-rich Package Checking Accounts that carry higher deposit account management fees and high balance requirements to avoid the deposit account management fee. Customers in this segment have multiple deposit, investment and loan accounts with large balances. These customers produce checking account profit for their financial institutions through deposit balance spread and debit card interchange.

In this environment, many checking customers deliver little or no profitability to their financial institutions. Generally speaking, this Single-Service, Low Activity segment carries sufficient balances to avoid deposit account management fees but not enough to generate meaningful spread revenue and perform very few spending transactions (including debit card, which produces interchange income for the financial institution). This segment has ‘thin’ banking relationships and performs few transactions because there is no incentive to expand.

In addition, new legislation, specifically modifications to Regulation E, have negatively impacted checking account profitability across most segments. Those modifications required customers to opt-in to overdraft coverage for debit card and ATM transactions. As a result, account fee income (both deposit account management fees and interchange) from those transactions has deteriorated, which has significant impact on the profitability of Low Balance Transactor customers to their financial institutions.

Proposed legislation promises to further challenge financial institutions' ability to generate profit from low-balance customers, particularly those with free checking accounts.

Such legislation includes:
1. Proposed guidance from the FDIC that will extend Regulation E requirements to non-electronic transactions, as well as limit the number of overdraft fees charged per day/year and regulate posting order;
2. Proposed Durbin Amendment that will limit debit card interchange to $0.12 per transaction regardless of size; and
3. Proposed Harkin Amendment that will regulate ATM fees.
   As a result of these changes, financial institutions will be forced to re-think product design and sales objectives in order to maintain checking account profitability, which for some segments will be impossible via the checking account alone. Therefore, the focus of financial institutions will shift from net new checking accounts to net new relationships and lifetime profitability.

Several financial institutions have already eliminated free checking or modified their basic checking account product offerings in response to the new/proposed legislation in an attempt to recover some of the lost fee income. Modified basic checking products now carry a moderate deposit account management fee, typically between $4 and $12, and require one or more of the following monthly behaviors to waive the deposit account management fee:
1. Maintain a moderate balance in the account, typically between $500 and $2,000;
2. Perform a certain number of transactions, sometimes limited to a specific channel (e.g., perform one credit card transaction per month or 5 electronic bill pay transactions per month); and/or
3. Establish a direct deposit and/or electronic transfer to a linked savings account.

As a result, these same financial institutions are also modifying their feature-rich Package Checking accounts to have broader appeal among customers. Common trends include:
1. Reducing the deposit account management fee (typically between $15 and $25);
2. Reducing the balance requirements to waive the deposit account management fee (typically between $5,000 and $25,000); and
3. Expanding the products/balances that can count towards the balance requirements to waive the deposit account management fee.
   Thus, while Basic Checking has become more restrictive, financial institutions have reduced the barriers of entry for Package Checking accounts.

These emerging checking account trends do address several profitability challenges caused by the Single-Service, Low Activity segment and the new/pending legislation that impacts profitability across all customer segments, including encouraging profitable behavior and providing a new source of fee income through deposit account management fees. Unfortunately, there are also issues with the approach many financial institutions are taking, including:
1. Deposit account management fees are punitive, penalizing customers for not performing certain behaviors (negative incentive);
2. Deposit account management fees are all-or-none such that if customers do not fully perform qualifying behaviors, they are charged the entire fee (e.g., if the requirement to avoid the deposit account management fee is to perform five debit card transactions and the customer performs four, they are charged the full deposit account management fee); and
3. Most financial institutions only require 1 to 3 behaviors to avoid the deposit account management fee, which does little to deepen customer loyalty.

In view of these trends and limitations in the art, it is thus desired to come up with a deposit account alternative that better suits the needs of the customers while improving the profitability of the account management by the financial institutions. The system and methods of the present invention addresses these needs in the art.

### SUMMARY

The invention addresses the above-mentioned and other limitations of the prior art by providing a system for implementing a novel pricing method that can apply to both Basic and Package Checking accounts as they exist today. In other words, there is no requirement to modify existing features and/or functionality associated with the account in order to implement the methodology of the invention. Instead, the method includes implementation of a competitive deposit account management fee (as determined by the financial institution) that can be reduced or eliminated when the customer performs certain banking activities.

In particular, the pricing method implemented in accordance with the methods of the invention assigns a specific value (also called ‘credits’) to each eligible banking activity. The activities and associated values are determined by the participating financial institution and communicated to the customer at account opening. Typically, the value associated with a single banking activity is less than the deposit account management fee, requiring customers to perform multiple activities to eliminate the deposit account management fee in the account management period (typically a month). Eligible banking activities include, but are not limited to: direct deposit; performing a certain number of debit card, credit card and/or online banking transactions; automatically transferring funds to a savings account each account management period; enrolling in and maintaining overdraft protection; enrolling in and receiving electronic statements; tenure; account, deposit and/or relationship balances; and presence of other deposit or lending products. Customers do not need to pick the banking activities for which they would like to receive credits. The system of the invention automatically monitors all activities of the customers and calculates credits for every activity for every customer. The activities used to waive/reduce the deposit account management fee for a particular customer may be different from account management period to account management period.

At the end of each account management cycle, the system of the invention calculates the number of credits earned by each customer based on their respective activities. The system then applies those credits to the present period deposit account management fee. If the calculated credits are less than the deposit account management fee, meaning the customer is responsible for some portion of the deposit account management fee, the system computes the revised deposit account management fee and provides it to the core deposit system where it will be charged. If the calculated credits are equal to or greater than the deposit account management fee, meaning the deposit account management fee is eliminated, the system sends a $0 fee record to the core deposit system.

In the event credits earned in the present period are greater than the deposit account management fee, the system computes and stores the excess credits for use in subsequent periods (also called ‘carryover’ credits). The system supports the following usage of carryover credits:
Apply to subsequent period deposit account management fees should the customer not have enough credits that period to eliminate the deposit account management fee. In this case, the system automatically applies the necessary excess credits to the customer's deposit account management fee to bring the fee to $0 (thus removing those credits from the carryover credit balance).
Apply to subsequent period service fees, such as overdraft, insufficient funds, safety deposit box, standard checks, official checks, traveler's checks or ATM-related fees. Financial institutions may or may not elect to use this feature and, if they do, may require the credits to have some period of tenure before allowing the customer to use them (e.g., credits must be 12 months old).
Convert the carryover credits to alternative forms of value, such as rewards points or savings deposit. Financial institutions may or may not elect to use this feature and, if they do, may require the credits to have some period of tenure before allowing the customer to use them (e.g., credits must be 12 months old). An example of converting credits into alternative form of value includes depositing the credits into a linked savings account once a customer earns $50 in excess credits. Converting the excess credits to one or more alternative forms of value for the customer preferably includes providing a number of excess credits to conversion software in one of the financial institution's computer systems that converts the number of excess credits to the one or more alternative forms of value and reduces the excess credits by the number of excess credits converted by the conversion software.

The system of the invention further supports manual manipulation of the carryover balance. For example, a financial institution may want to increase the carryover balance at account opening, after a customer service event or during a promotion. The system of the invention also supports internal reporting for both performance management and accounting/finance functions.

In an exemplary embodiment, the system of the invention manages deposit account management fees charged by a financial institution for managing a deposit account for a customer. The system includes a database that stores deposit account information for customers, a memory that stores instructions for managing customer deposit accounts, and a processor that processes the instructions. In the exemplary embodiment, the instructions, when processed, cause the processor to:

assign credits to banking activities that may be performed with the financial institution by the customer;

establish a deposit account management fee for a deposit account management time period, the deposit account management fee corresponding to a predetermined number of the credits;

accumulate the customer's credits for the customer's banking activities during the deposit account management period and storing same in the database;

compare the number of accumulated credits stored in the database for the deposit account management period to the predetermined number of credits; and

if the number of accumulated credits is greater than or equal to the predetermined number of credits, satisfying the customer's deposit account management fee for the deposit account management time period and applying any excess credits to the deposit account management fee for one or more subsequent deposit account management periods or converting the excess credits to one or more alternative forms of value for the customer.

In the exemplary embodiment, the banking activities that are assigned credits include, but are not limited to direct deposit; performing a certain number of debit card, credit card and/or online banking transactions; automatically transferring funds to a savings account; enrolling in and maintaining overdraft protection; enrolling in and receiving electronic statements; tenure; account, deposit and/or relationship balances; and/or presence of other deposit or lending products. Each such banking activity is assigned a ‘credit’ value in currency denomination or a designated number of rewards points for each banking activity performed. The banking activities that receive credit and the credit values are preferably variable and are determined by the financial institution.

If it is determined that the number of accumulated credits for the deposit account management time period is less than the predetermined number of credits, the processor further automatically reduces the deposit account management fee by a corresponding value of such credits and charges the reduced deposit account management fee amount against the customer's deposit account unless excess credits are available from a previous period. On the other hand, if it is determined that the number of accumulated credits for the deposit account management time period is greater than the predetermined number of credits, the processor may also automatically reduce the deposit account management fee to zero and apply any excess credits to a subsequent deposit account management period should the customer have a number of credits in the subsequent deposit account management period that is less than the predetermined number of credits and thus the customer would otherwise pay at least a portion of the deposit account management fee for the subsequent deposit account management period. The processor also may accrue the excess credits for a set period of time or until a set number of excess credits is reached, at which time the excess credits may be used for service fees and/or converted to the one or more alternative forms of value for the customer. Such service fees may include one or more of fees for overdraft, insufficient funds, safety deposit box, standard checks, official checks, traveler's checks and ATM-related fees. The processor may track expiration of the excess credits, which expire after a predetermined period of time.

The database stores a record of the customer's banking activities during the deposit account management time period. A display preferably is provided to display all or portions of the record to authorized personnel of the financial institution. The system also may include software or an interface with incumbent technology that enables the financial institution to add or subtract credits from the customer's accumulated credits at the financial institution's discretion. For example, the financial institution may provide credits to customers that incur a negative customer experience. Software may also be provided for converting the number of excess credits to the alternative forms of value and for reducing the excess credits by the number of converted excess credits.

The scope of the invention further includes methods as used in conjunction with the system described herein as well as computer readable storage media that store instructions for implementing such methods. The full scope of the invention will be better understood by those skilled in the art from the following detailed description of the invention.

### BRIEF DESCRIPTION OF THE DRAWINGS

The above and other features and advantages of the invention will be apparent from the following detailed description of the figures, of which:

FIG. 1 illustrates a sample deposit account management fee system in accordance with the invention whereby the financial institution has the flexibility to determine which activities warrant a credit and the value of such credits.

FIG. 2 illustrates the method for calculating present period credits whereby the system receives formatted data from various host systems in order to determine how many activity credits were earned during the present period.

FIG. 3 illustrates an exemplary embodiment of the process implemented by the system to compute the present period deposit account management fee for each customer.

FIG. 4 illustrates an exemplary embodiment of the process for modifying the excess credit balance.

FIG. 5 illustrates the credit information that may be made available to bankers/representatives in accordance with the invention for the purpose of resolving customer questions or disputes related to their activity credits.

FIG. 6 illustrates the reporting capabilities for the system of the invention, which allows the financial institution to track the results of the program and identify opportunities for improvement.

FIG. 7 illustrates a server based system adapted to implement the deposit account management fee management system of the invention.

### DETAILED DESCRIPTION OF ILLUSTRATIVE EMBODIMENTS

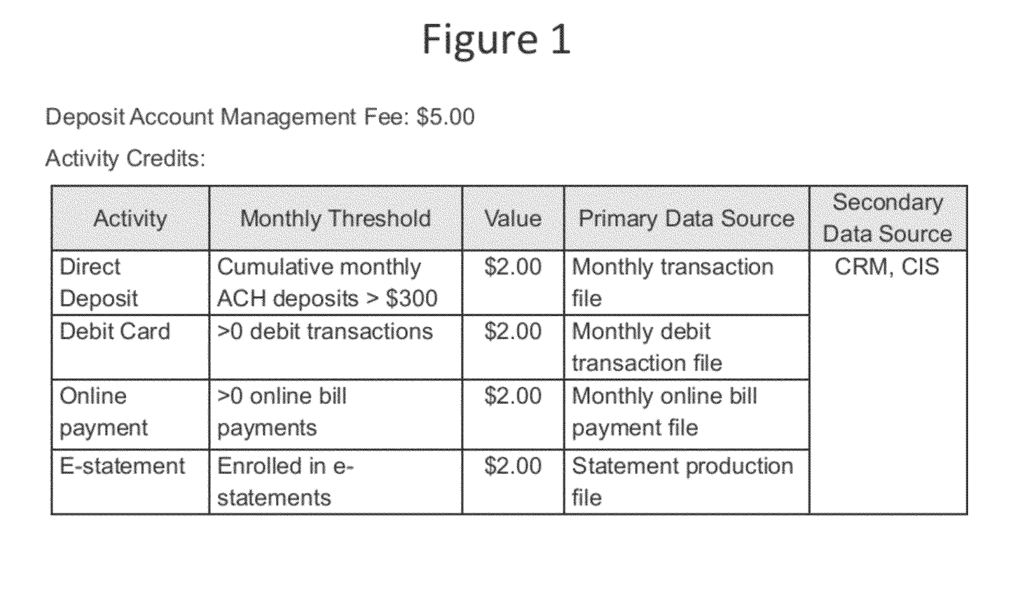

Certain specific details are set forth in the following description with respect to FIGS. 1-7 to provide a thorough understanding of various embodiments of the invention. Certain well-known details are not set forth in the following disclosure, however, to avoid unnecessarily obscuring the various embodiments of the invention. Those of ordinary skill in the relevant art will understand that they can practice other embodiments of the invention without one or more of the details described below. Also, while various methods are described with reference to steps and sequences in the following disclosure, the description is intended to provide a clear implementation of embodiments of the invention, and the steps and sequences of steps should not be taken as required to practice the invention.

The system and method described herein provides an innovative pricing method for deposit accounts that is highly customizable and can be used to drive specific customer behaviors that align with the unique goals and objectives of each participating financial institution. In addition to driving specific behaviors, it also accelerates the adoption of such behaviors through customer incentives.

The pricing method of the invention is based on ‘rewarding’ customers with credits for performing certain banking activities each account management period (e.g., month). The financial institution has influence on the banking activities eligible for credit(s), the threshold(s) that must be met in order to obtain the credit(s), the ‘currency’ of the credits, and the ultimate value of such credit(s). For example, sample banking activities that may be eligible for credits include, but are not limited to, direct deposit; performing a certain number of debit card, credit card and/or online banking transactions; automatically transferring funds to a savings account each account management period; enrolling in and maintaining overdraft protection; enrolling in and receiving electronic statements; tenure; account, deposit and/or relationship balances; presence of other deposit or lending products.

FIG. 1 displays sample thresholds for each eligible banking activity. The sample pricing method in FIG. 1 awards credits for direct deposit, debit card transactions, online bill payments and e-statement. Of course, these activities are only exemplary. Those skilled in the art will appreciate that any appropriate customer activities with the financial institution may be incorporated into the system described herein.

In the example of FIG. 1, customers meet the direct deposit threshold if they have cumulative ACH credits of at least $300 during the present period and meet the debit card threshold if they complete at least one debit card transaction in the present period. Also, customers meet the online bill payment threshold if they complete at least one online bill payment in the present period and meet the e-statement threshold if they receive their present period account statement electronically. However, it will be appreciated by those skilled in the art that the deposit account management fee system of FIG. 1 gives the financial institution the flexibility to determine which activities warrant a credit and the value of such credits. Credits can be treated as currency or any other form of measurement (i.e. points). The example of FIG. 1 provides customers $2 activity credits for performing any of the incentivized activities during the present period: direct deposit (defined as cumulative ACH credits greater than $300 in the current account management period); at least one debit card transaction; at least one online bill payment; and receiving their account statement electronically.

Credit currency for the accumulated points can take many forms including, but not limited to, US dollars or other local currency, rewards program points (i.e. debit and credit card rewards program), and/or new form of currency (i.e. ‘fee credits’). The sample pricing method in FIG. 1 expresses credits in the form of US dollars.

The value of such credits are determined by the financial institution. While there are no restrictions on the value that can be assigned to each activity, they can be limited by the amount of the deposit account management fee for the current account management period (typically one month) and the number of activities eligible for an activity credit. The sample pricing method in FIG. 1 carries a monthly deposit account management fee of $5 and has four activities eligible for credit. In order to provide the customer with flexibility in terms of eliminating the deposit account management fee and still have the ability to achieve excess credits, the value assigned to each activity is $2. Of course, those skilled in the art will appreciate that significantly more sophisticated account scenarios may be implemented using the techniques of the invention.

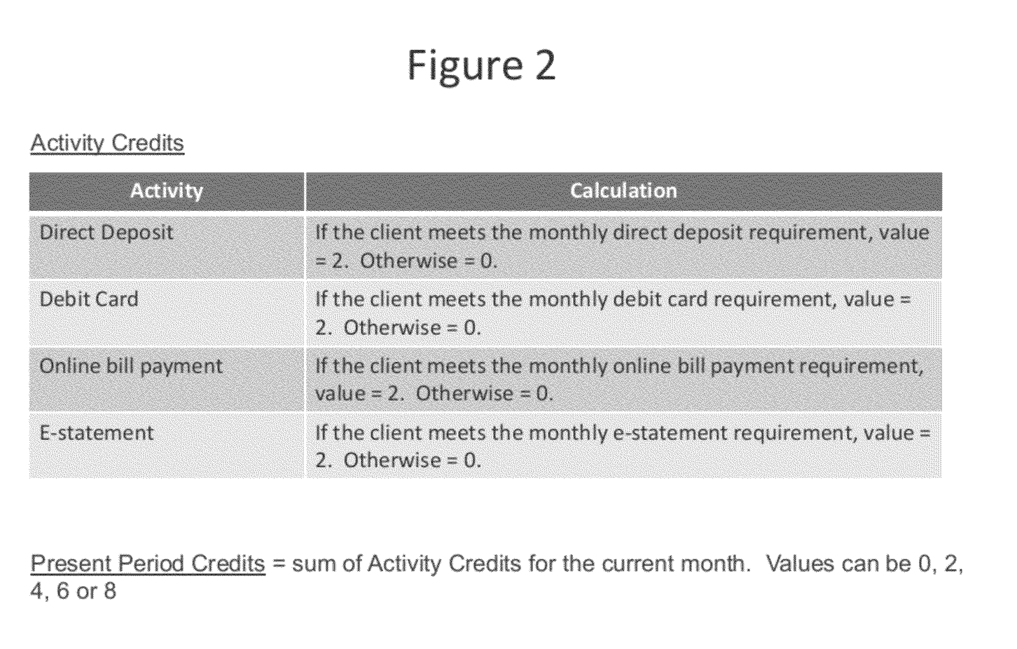

Ultimately, the system design depends on the data available at a participating financial institution. The supporting system for this pricing method utilizes transaction and/or behavioral data that already exists in the financial system of the financial institution. Before the system of the invention can compute the present period credits (as outlined below with respect to FIG. 2), the source data must be formatted either by the originating system or through the use of a conversion program. Once the data is in the proper format, it can be uploaded to the system of the invention. FIG. 1 identifies the primary data sources for each of the indicated activities as well as the secondary data sources including, for example, a customer relationship management system (CRM) and a customer information system (CIS).

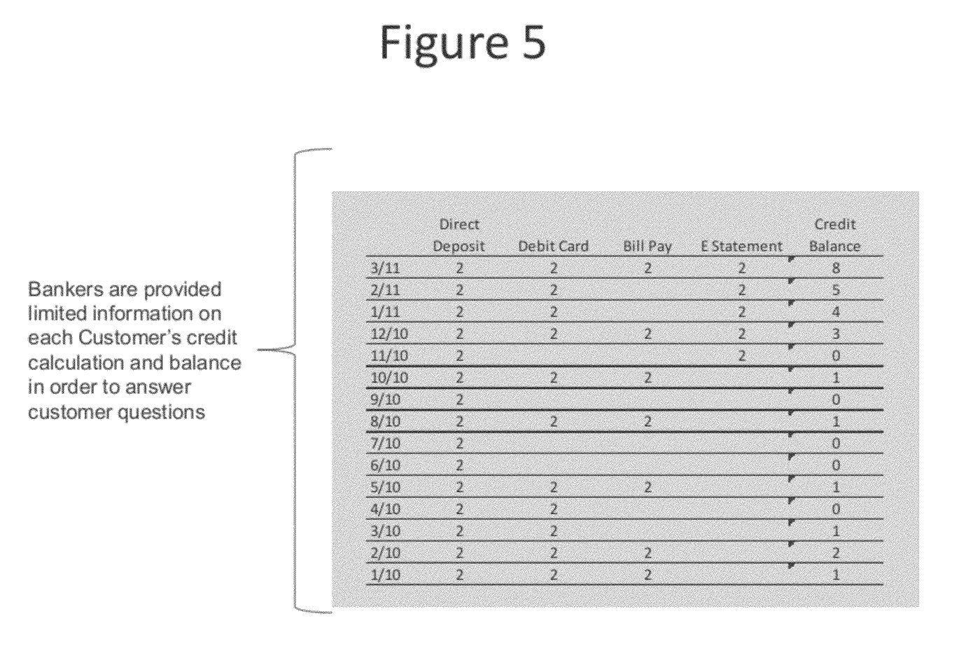

FIG. 2 illustrates a method for calculating present period credits whereby the system receives formatted data from various host systems in order to determine how many activity credits were earned during the present period. In accordance with the invention, activity credits are computed for each behavior and summed to determine the total present period credits at the customer level. In an exemplary embodiment, once the appropriate data is uploaded to the system of the invention, the first pricing step can occur, which is calculating the present period credits. Present period credits are computing based on the Activity Credit elements selected by the financial institution, as described above with respect to FIG. 1, as well as the selected Monthly Threshold and Value/Currency for the selected activities and credits. The calculation routines may be relatively straightforward. For example, if the customer meets specific activity thresholds in the present period, the customer receives the associated credit for that behavior. The system then accumulates (sums) the activity credits earned by each customer to compute the present period credits. As described below with respect to FIG. 5, these calculations may be made available to certain stakeholders in a participating financial institution for the purpose of resolving customer questions or disputes related to their activity credits.

The present period credits are then used to compute the present period deposit account management fee. The deposit account management fee calculation occurs on/after the last business day of the account management cycle after all transactions have posted and all excess credit modifications are completed.

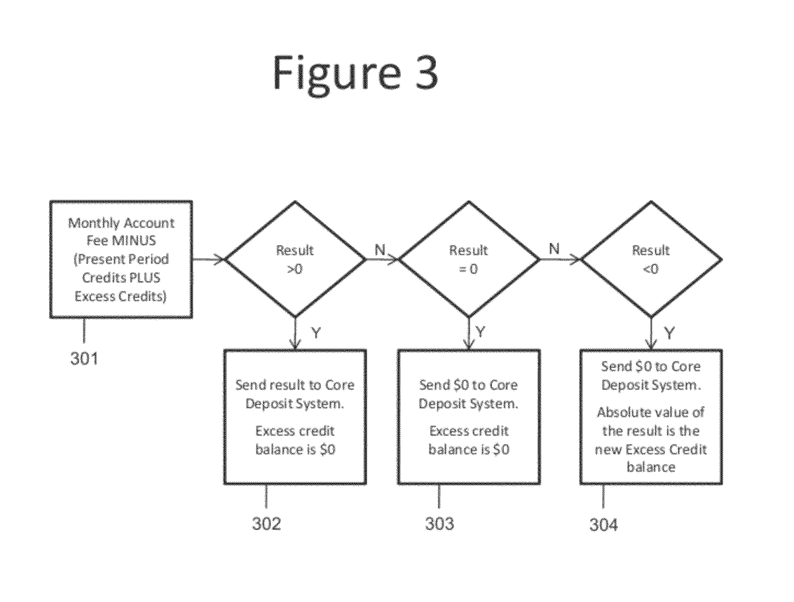

FIG. 3 illustrates an exemplary embodiment of the process implemented by the system of the invention to compute the present period deposit account management fee for each customer. As illustrated, the system compares the deposit account management fee and the present period credits plus any excess credits at step 301. For example, the system subtracts any present period activity credits plus any excess credits from the stated deposit account management fee for the current account management period. In FIG. 1, a stated deposit account management fee of $5 is used. Based on the result of the comparison, the system performs various tasks.
Result greater than $0. At step 302, the system populates the result on a data file that is sent to the core deposit system where the deposit account management fee will be charged to the customer. The excess credit balance is zero.
Result equal to $0. At step 303, the system populates $0 for the deposit account management fee on a data file that is sent to the core deposit system. The excess credit balance is again zero.
Result is less than $0. At step 304, the system populates $0for the deposit account management fee on a data file that is sent to the core deposit system. The absolute value of the remainder becomes the excess credit balance to be used in subsequent periods.

In the event credits earned in the present period are greater than the deposit account management fee for the current account management period, the system computes and stores the excess credits for use in subsequent periods (also called ‘carryover’ credits). The system supports the following usage of carryover credits:
Apply to subsequent period deposit account management fees should the customer not have enough credits that account management period to eliminate the deposit account management fee. In this case, the system automatically applies the necessary excess credits to the customer's deposit account management fee to bring the deposit account management fee to $0 (thus removing those credits from the carryover credit balance).
Apply to subsequent period service fees, such as overdraft, insufficient funds, safety deposit box, standard checks, official checks, traveler's checks or ATM-related fees. Financial institutions may or may not elect to use this feature and, if they do, may require the credits to have some period of tenure before allowing the customer to use them (e.g., credits must be 12 months old).
Convert the carryover credits to alternative forms of value, such as rewards points or savings deposit. Financial institutions may or may not elect to use this feature and, if they do, may require the credits to have some period of tenure before allowing the customer to use them (e.g., credits must be 12 months old). An example of converting credits into alternative form of value includes depositing the credits into a linked savings account once a customer earns $50 in excess credits.

The system of the invention further supports manual manipulation of the carryover balance. For example, a financial institution may want to increase the carryover balance at account opening, after a customer service event or during a promotion. The system of the invention also supports internal reporting for both performance management and accounting/finance functions.

In the event the excess credit balances must be modified outside of the normal calculation routine, financial institutions have the ability to grant access to specific stakeholders to modify the excess credit balance. Sample scenarios that might require ad hoc modifications include error, banker discretion, marketing promotion, compensation for negative customer experiences, or conversion to alternative forms of value. Based on the needs and technology of the financial institution, this functionality can reside in the Sales and Service Platform or directly in the system itself. All excess credit modifications require a date and explanation, which can be used to monitor compliance and/or resolve customer service issues in subsequent periods. Depending on the solution selected, the system may be required to manage user credentials and/or store the date, time, reason and user for each modification.

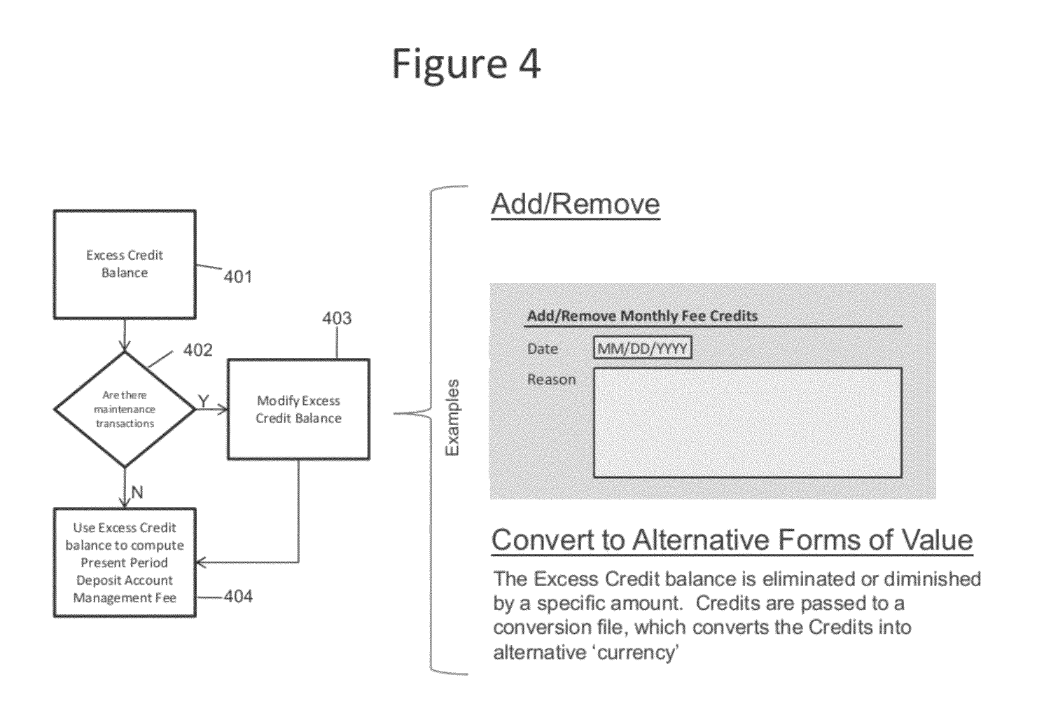

In the exemplary embodiment, the system overrides the existing excess credit balance when any modifications are processed. All excess credit modifications occur before the deposit account management fee calculation routine as described in FIG. 4. As illustrated on the right hand side of FIG. 4, an account profile screen from the financial institution's sales and service platform may give the financial institution the ability to add/remove deposit account management fee credits or to eliminate or diminish credits by a specified amount under particular circumstances. The resulting credits may also be passed to a conversion file for conversion into points or any other designated form of alternative “currency.” Stakeholders eligible to modify the excess credit balance are determined by the financial institution. Such determinations, as well as the technology capabilities of the financial institutions dictate where this capability resides (sales and service platform, directly in the system, etc.). All modifications require a date and explanation, which can be used to monitor compliance and/or resolve customer service issues in subsequent periods.

FIG. 4 also illustrates an exemplary embodiment of the process for modifying the excess credit balance. All excess credit modifications create a maintenance transaction that is processed periodically (e.g., nightly). In the event credit modifications occur on the same day as the deposit account management fee calculation, all deposit account management fee transactions are processed first. As illustrated in FIG. 4, if there is an excess credit balance at step 401, and it is determined at step 402 that there are deposit account management fee transactions, then the excess credit balance is determined at step 403. At step 404, the excess credit balance is used to compute the present period deposit account management fee.

In the event excess credits are converted to alternative forms of value, the system produces a data file that can be converted to a format acceptable to the receiving host system (i.e. rewards platform). The system modifies the excess credit balance by the amount of the credits transferred out.

Deposit account management fee calculations and excess credit balances at the customer level are made available to all customer-facing and back office stakeholders. Based on the needs and technology of the financial institution, this functionality can reside in the sales and service platform or in a stand-alone system that is provided at a secure location inside the financial institution firewall, such as on an Intranet. The system of the invention also enables the financial institution to utilize the customer's credits in a marketing campaign or provide credits to customers that incur a negative customer experience. The system may also preserve the credits and associated data in a database for a set period of time such as up to 24 months for purposes of such reporting. A sample display is provided in FIG. 5.

FIG. 5 illustrates the credit information that may be made available to bankers/representatives in accordance with the invention for the purpose of resolving customer questions or disputes related to their activity credits. In addition to providing the credits computed each account management period by activity for a predetermined period of time (e.g., the last 24 months), the system also displays the ending excess credit balance for each account management period. The technology capabilities of the participating financial institution determine where this data resides. As noted above, it could be integrated into the sales and service platform or stored in a database and accessed via web-based software hosted inside the financial institution firewall (i.e. Intranet). As will be appreciated by those skilled in the art, this information is important for resolving customer questions or disputes related to their activity credits.

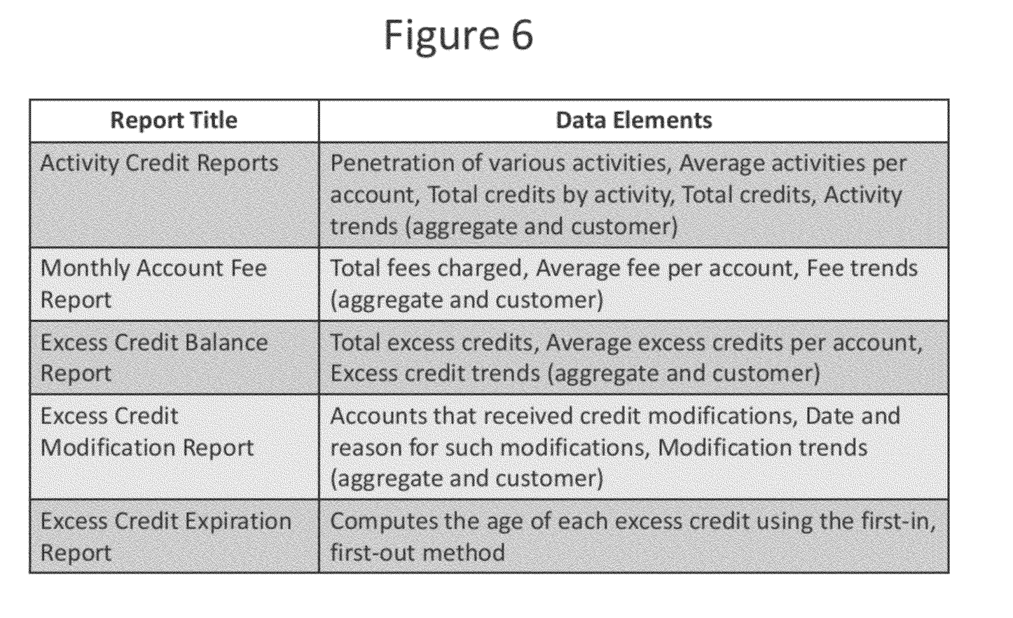

The system of the invention also includes a module for making available data/reporting so the financial institution can track the results of the program and identify opportunities for improvement. FIG. 6 illustrates the reporting capabilities for the system of the invention from an account profile screen shot from the financial institution's sales and service platform. The report function allows the financial institution to track the results of the program and identify opportunities for improvement. The standard reports include an activity credit report, deposit account management fee report for the account management period, excess credit balance report, excess credit modification report and excess credit expiration report. Custom reports are available upon request.

Preferably, the system provides a standard suite of reports that can be set to run automatically each account management period or as needed. The reports are exported in common data and text file formats for use in other applications, such as Excel or Word. Additional reporting is available on an ad hoc basis using the data elements that reside in the system. A standard suite of reports may include by way of example:
Activity Credit Reports. Data elements include penetration of various activities, average activities per account, total credits by activity, total credits, activity trends (aggregate and customer). The financial institution can use this report to measure the effectiveness of the program in engaging customers in profit-enhancing activities.
Monthly Account Fee Report. Data elements include total fees charged, average fee per account, fee trends (aggregate and customer). The financial institution can use this report to measure the monthly account fee profit, as well as the soft cost associated with the activity credits.
Excess Credit Balance Report. Data elements include total excess credits, average excess credits per account, excess credit trends (aggregate and customer). The financial institution can use this report to manage the liability associated with the excess credits.
Excess Credit Modification Report. Data elements include accounts that received credit modifications, date and reason for such modifications, modification trends (aggregate and customer). The financial institution can use this report to measure compliance with modification guidelines and monitor for abuse.
Excess Credit Expiration Report. Data elements include age of each excess credit using the first-in, first-out method. The financial institution can use this report to expire excess credits according to their program design (if necessary).

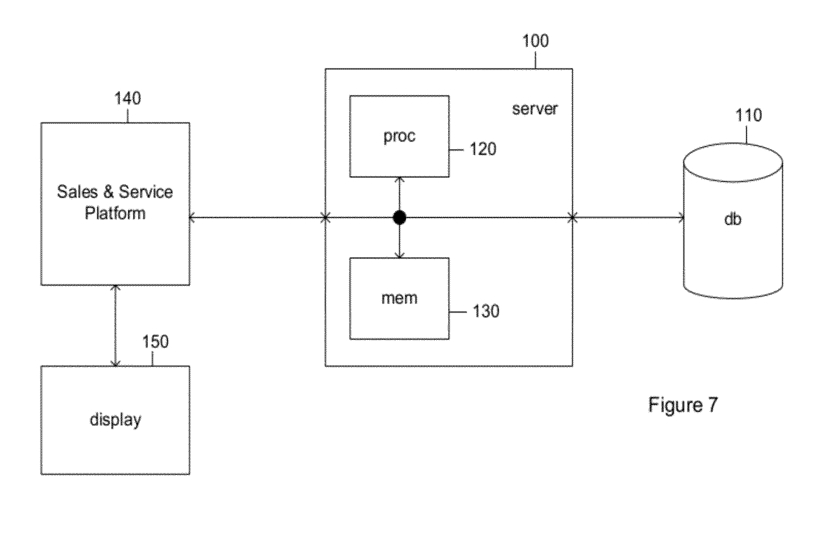

FIG. 7 illustrates a server based system adapted to implement the deposit account management fee system of the invention. As illustrated, a server 100 is connected to a database 110 that stores deposit account information for customers and includes a processor 120 that runs the deposit account management fee software from memory 130 to perform the account management functions described herein and to store the results in the database 110. As illustrated, the server 100 is preferably connected to the financial institution's sales and service platform 140 or other information technology platforms (not shown) within the financial institution to facilitate editing and reporting via a screen interface 150 as described above with respect to FIGS. 4-6.

Those skilled in the art will appreciate that the server 100 may include computing environments implemented by a personal computer, a mainframe, or the like. According to the illustrated embodiment, the computing environment includes hardware components and/or software components such that the resulting computing environment may be used to execute applications such as internet applications, operating systems, server applications, customer applications, database applications, or the like. For example, the computing environment on server 100 may be used to execute the deposit account management fee software for implementing the methods described herein with respect to FIGS. 1-6. Those skilled in the art will also appreciate that the server 100 may reside within the financial institution's technology infrastructure (i.e. inside the firewall) or on a separate platform that uses industry standard protocols for data storage and transmission with the financial institution's technology infrastructure.

In an exemplary embodiment, the processor 120 of server 100 is in operative communication with instruction memory 130 with instructions for implementing an operating system and the application programs for implementing the techniques of the invention. The processor 120 may include a standardized processor, a specialized processor, a microprocessor, or the like. The processor executes instructions including, for example, instructions for implementing the processes described with respect to FIG. 1-6.

Instruction memory 130 stores the instructions that may be executed by the processor 120 of server 130. The instruction memory 130 may include computer readable storage media in the form of volatile and/or nonvolatile memory such as random access memory (RAM), read only memory (ROM), cache, Flash memory, a hard disk, or any other suitable tangible storage component. In one embodiment, the instruction memory 130 may be a separate component in communication with the processor 120, while in another embodiment, the instruction memory 130 may be integrated into the processor 120 of server 100.

Those skilled in the art also will readily appreciate that many additional modifications and scenarios are possible in the exemplary embodiment without materially departing from the novel teachings and advantages of the invention. Accordingly, any such modifications are intended to be included within the scope of this invention as defined by the following exemplary claims.

What is claimed:

1. A computer-implemented method for managing deposit account management fees charged by a financial institution for managing a deposit account for a customer, comprising the steps of:
assigning credits to banking activities that may be performed with the financial institution by the customer;
establishing a deposit account management fee for a deposit account management time period, the deposit account management fee corresponding to a predetermined number of said credits;
the computer accumulating the customer's credits for the customer's banking activities during the deposit account management period and storing same in a database; and
the computer comparing the accumulated credits stored in said database for said deposit account management period to said predetermined number of credits and, if the number of accumulated credits is greater than or equal to the predetermined number of credits, satisfying the customer's deposit account management fee for the deposit account management time period and applying any excess credits to the deposit account management fee for one or more subsequent deposit account management periods or converting the excess credits to one or more alternative forms of value for the customer.

2. The method of claim 1, wherein the banking activities that are assigned credits in said assigning step include direct deposit; performing a certain number of debit card, credit card and/or online banking transactions; automatically transferring funds to a savings account;
enrolling in and maintaining overdraft protection; enrolling in and receiving electronic statements; tenure; account, deposit and/or relationship balances; and/or presence of other deposit or lending products.

3. The method of claim 1, wherein each banking activity is assigned in said assigning step a ‘credit’ value in currency denomination or a designated number of rewards points for each banking activity performed.

4. The method of claim 1, wherein the banking activities that receive credit and the credit values assigned in said assigning step are variable and are determined by the financial institution.

5. The method of claim 1, wherein if it is determined in said comparing step that the number of accumulated credits for the deposit account management time period is less than the predetermined number of credits, performing the steps of automatically reducing the deposit account management fee by a corresponding value of such credits and charging the reduced deposit account management fee amount against the customer's deposit account.

6. The method of claim 1, wherein said excess credits are automatically applied to a subsequent deposit account management period should the customer have a number of credits in the subsequent deposit account management period that is less than said predetermined number of credits and thus the customer would otherwise pay at least a portion of the deposit account management fee for the subsequent deposit account management period.

7. The method of claim 1, further comprising the steps of accruing excess credits for a set period of time or until a set number of excess credits is reached, at which time the excess credits are then used for service fees and/or converted to said one or more alternative forms of value for the customer.

8. The method of claim 7, wherein said service fees include at least one of fees for overdraft, insufficient funds, safety deposit box, standard checks, official checks, traveler's checks and ATM-related fees.

9. The method of claim 7, further comprising tracking expiration of the excess credits, wherein said excess credits expire after a predetermined period of time.

10. The method of claim 1, further comprising the steps of storing a record of the customer's banking activities during said deposit account management time period and displaying all or portions of said record to authorized personnel of the financial institution.

11. The method of claim 1, further comprising enabling the financial institution to add or subtract credits from the customer's accumulated credits at the financial institution's discretion.

12. The method of claim 11, further comprising enabling the financial institution to utilize the customer's credits in a marketing campaign or provide credits to customers that incur a negative customer experience.

13. The method of claim 1, wherein converting the excess credits to one or more alternative forms of value for the customer includes the steps of providing a number of excess credits to conversion software that converts the number of excess credits to said one or more alternative forms of value and reducing the excess credits by the number of excess credits converted by the conversion software.

14. A system for managing deposit account management fees charged by a financial institution for managing a deposit account for a customer, comprising:
a database that stores deposit account information for customers;
a memory that stores instructions for managing customer deposit accounts; and
a processor that processes said instructions to:
assign credits to banking activities that may be performed with the financial institution by the customer;
establish a deposit account management fee for a deposit account management time period, the deposit account management fee corresponding to a predetermined number of said credits;
accumulate the customer's credits for the customer's banking activities during the deposit account management period and storing same in said database; and
compare the number of accumulated credits stored in said database for said deposit account management period to said predetermined number of credits and, if the number of accumulated credits is greater than or equal to the predetermined number of credits, satisfying the customer's deposit account management fee for the deposit account management time period and applying any excess credits to the deposit account management fee for one or more subsequent deposit account management periods or converting the excess credits to one or more alternative forms of value for the customer.

15. The system of claim 14, wherein the banking activities that are assigned credits include direct deposit; performing a certain number of debit card, credit card and/or online banking transactions; automatically transferring funds to a savings account; enrolling in and maintaining overdraft protection; enrolling in and receiving electronic statements; tenure; account, deposit and/or relationship balances; and/or presence of other deposit or lending products.

16. The system of claim 14, wherein the processor further executes instructions for assigning each banking activity a ‘credit’ value in currency denomination or a designated number of rewards points for each banking activity performed.

17. The system of claim 14, wherein the banking activities that receive credit and the credit values are variable and are determined by the financial institution.

18. The system of claim 14, wherein if it is determined that the number of accumulated credits for the deposit account management time period is less than the predetermined number of credits, the processor further processes instructions for automatically reducing the deposit account management fee by a corresponding value of such credits and charging the reduced deposit account management fee amount against the customer's deposit account.

19. The system of claim 14, wherein the processor further automatically applies said excess credits to a subsequent deposit account management period should the customer have a number of credits in the subsequent deposit account management period that is less than said predetermined number of credits and thus the customer would otherwise pay at least a portion of the deposit account management fee for the subsequent deposit account management period.

20. The system of claim 14, wherein the processor further executes instructions for accruing excess credits for a set period of time or until a set number of excess credits is reached, at which time the excess credits are then used for service fees and/or converted to said one or more alternative forms of value for the customer.

21. The system of claim 20, wherein said service fees include at least one of fees for overdraft, insufficient funds, safety deposit box, standard checks, official checks, traveler's checks and ATM-related fees.

22. The system of claim 20, wherein said processor further executes instructions for tracking expiration of the excess credits, wherein said excess credits expire after a predetermined period of time.

23. The system of claim 14, wherein said processor further executes instructions for storing a record of the customer's banking activities during said deposit account management time period in said database.

24. The system of claim 23, further comprising a display that displays all or portions of said record to authorized personnel of the financial institution.

25. The system of claim 14, wherein the processor further executes instructions for enabling the financial institution to add or subtract credits from the customer's accumulated credits at the financial institution's discretion.

26. The system of claim 25, wherein the processor further executes instructions for providing credits to customers that incur a negative customer experience.

27. The system of claim 14, wherein the processor further executes instructions for converting the number of excess credits to said one or more alternative forms of value and for reducing the excess credits by the number of converted excess credits.

28. A computer readable storage medium that stores instructions that when executed by a processor causes said processor to manage deposit account management fees charged by a financial institution for managing a deposit account for a customer by performing the steps of:
assigning credits to banking activities that may be performed with the financial institution by the customer;
establishing a deposit account management fee for a deposit account management time period, the deposit account management fee corresponding to a predetermined number of said credits;
accumulating the customer's credits for the customer's banking activities during the deposit account management period and storing same in a database; and
comparing the accumulated credits stored in said database for said deposit account management period to said predetermined number of credits and, if the number of accumulated credits is greater than or equal to the predetermined number of credits, satisfying the customer's deposit account management fee for the deposit account management time period and applying any excess credits to the deposit account management fee for one or more subsequent deposit account management periods or converting the excess credits to one or more alternative forms of value for the customer.

29. The medium of claim 28, further comprising instructions that when executed cause the processor to automatically reduce the deposit account management fee by a corresponding value of credits and charge the reduced deposit account management fee amount against the customer's deposit account when it is determined that the number of accumulated credits for the deposit account management time period is less than the predetermined number of credits.

30. The medium of claim 28, further comprising instructions that when executed cause the processor to automatically apply said excess credits to a subsequent deposit account management period should the customer have a number of credits in the subsequent deposit account management period that is less than said predetermined number of credits and thus the customer would otherwise pay at least a portion of the deposit account management fee for the subsequent deposit account management period.

31. The medium of claim 28, further comprising instructions that when executed cause the processor to accrue excess credits for a set period of time or until a set number of excess credits is reached, at which time the excess credits are then used for service fees and/or converted to said one or more alternative forms of value for the customer.

32. The medium of claim 31, further comprising instructions that when executed cause the processor to track expiration of the excess credits, wherein said excess credits expire after a predetermined period of time.

33. The medium of claim 28, further comprising instructions that when executed cause the processor to store a record of the customer's banking activities during said deposit account management time period and to display all or portions of said record to authorized personnel of the financial institution.

34. The medium of claim 28, further comprising instructions that when executed cause the processor to enable the addition or subtraction of credits from the customer's accumulated credits at the financial institution's discretion.

35. The medium of claim 28, further comprising instructions that when executed cause the processor to convert the number of excess credits to said one or more alternative forms of value and to reduce the excess credits by the number of converted excess credits.
